(19) United States
(12) Patent Application Publication
(10) Pub. No.: US 2025/0179752 A1
(43) Pub. Date: Jun. 5, 2025

(54) CONSTRUCTION METHOD FOR UPLIFT PILE

(71) Applicants: ZHENGZHOU UNIVERSITY, Zhengzhou City (CN); HuangHuai University, Zhumadian City (CN); Zhengzhou Urban Construction Group Investment Ltd., Zhengzhou City (CN)

(72) Inventors: Tonghe ZHOU, Zhengzhou City (CN); Xiuyun CHEN, Zhumadian City (CN); Jingwei ZHANG, Zhengzhou City (CN); Hao ZHANG, Zhengzhou City (CN); Yan YANG, Zhumadian City (CN); Wei GAO, Zhengzhou City (CN); Xinjun GAO, Zhengzhou City (CN); Haijun LU, Zhengzhou City (CN); Qing LI, Zhengzhou City (CN); Hua LI, Zhengzhou City (CN); Qianli LIU, Zhengzhou City (CN); Ke LI, Zhengzhou City (CN)

(21) Appl. No.: 18/967,388

(22) Filed: Dec. 3, 2024

(30) Foreign Application Priority Data
Dec. 4, 2023 (CN) 202311645239.X

(51) Int. Cl. E02D 5/56; E02D 5/28

(52) U.S. Cl. CPC E02D 5/56; E02D 5/285; E02D 2200/1671

(57) ABSTRACT

Provided is a construction method for an uplift pile, including the following steps: Step one, measuring and positioning to obtain an accurate construction site of an uplift pile; Step two, constructing a pile hole underground at the construction site; Step three, pouring a curable material in the pile hole; and Step four, spirally implanting a precast pile body into the pile hole before the curable material is consolidated. The precast pile body is provided with multiple groups of screw-in structures at intervals in an axial direction for screwing the precast pile body into the pile hole, thus solving the disadvantages of long construction period and low construction efficiency in the existing monolithic cast-in-place construction of uplift piles, and the technical problems of great environmental impact, high geological requirements, easy damage to pile body, and easy pile explosion in a pile sinking mode of a precast pile.

### CROSS-REFERENCE TO RELATED APPLICATION

This patent application claims the benefit and priority of Chinese Patent Application No. 202311645239.X, filed with the China National Intellectual Property Administration on Dec. 4, 2023, the disclosure of which is incorporated by reference herein in its entirety as part of the present application.

### TECHNICAL FIELD

The present disclosure belongs to the technical field of uplift pile construction, and in particular to a construction method for an uplift pile.

### BACKGROUND

In recent years, the development of above-ground space is nearly saturated. In order to adapt to economic development, the development and application of underground space has become the focus, but the existence of groundwater requires that the anti-floating problem under a vertical load should be considered when designing underground structures. Meanwhile, the uplift problem needs to be considered in more and more high-rise buildings, high-rise buildings, transmission line poles and numerous buildings (structures).

At present, the uplift problem is generally solved using the uplift pile. The uplift pile mainly relies on the friction between pile body and stratum to resist axial force and bear vertical uplift force, which is widely used in anti-floating of large basements, uplift of high-rise buildings, uplift of offshore wharf platforms, anchor pile foundations of suspension bridges and cable-stayed bridges, etc.

The uplift piles include constant-section uplift piles, underreamed uplift piles and miniature uplift piles. The existing construction methods for uplift piles mainly include a cast-in-place construction process, and a precast pile process. The cast-in-place process includes digging a pile hole in the stratum, and then pouring and setting to form a pile body. However, the cast-in-place construction process has some problems, such as complex construction process, long construction period, difficult pile formation, serious environmental pollution, and to-be-improved economic benefits. Meanwhile, the traditional precast piles also have some problems in pile sinking, for example, hammer piling often causes pile top fragmentation, pile body fracture and pile body inclination, and has obvious influence on the surrounding environment; and the static piling cannot drive the pile into hard rock stratum, and thus is generally not applicable in shallow rock stratum. Moreover, the static piling requires relatively uniform geology, otherwise it is prone to pile explosion. In addition, for the reinforcement and underpinning of the existing buildings, the compressive and uplift precast pile processes capable of meeting narrow space construction mainly include an anchor static pressure method and a high-frequency vibration method, etc., and the construction tools and methods are relatively backward, with low construction efficiency and relatively high cost.

Therefore, there is a need to provide an improvement technical solution for the disadvantages in the prior art.

### SUMMARY

An objective of the present disclosure is to provide a construction method for an uplift pile, thereby solving the disadvantages of long construction period and low construction efficiency in the existing monolithic cast-in-place construction of uplift piles, and the technical problems of great environmental impact, high geological requirements, easy damage to pile body, and easy pile explosion in a pile sinking mode of a precast pile.

To achieve the objective above, a construction method for an uplift pile provided by the present disclosure provides the following technical solution.

A construction method for an uplift pile includes the following steps:
Step one, measuring and positioning to obtain an accurate construction site of an uplift pile;
Step two, constructing a pile hole underground at the construction site;
Step three, pouring a curable material in the pile hole; and
Step four, spirally implanting a precast pile body into the pile hole before the curable material is consolidated, where the precast pile body is provided with multiple groups of screw-in structures at intervals in an axial direction for screwing the precast pile body into the pile hole.

As a further preferred technical solution, a diameter of the precast pile body is less than an inner diameter of the pile hole, and the curable material is set to form an expanding layer of the precast pile body.

Each group of screw-in structure includes two helical plates crossed at a set angle, each helical plate extends spirally along an outer side of the precast pile body, and the two helical plates are arranged on the precast pile body in a staggered manner.

As a further preferred technical solution, each helical plate extends about 180° around a circumferential direction of the precast pile body.

As a further preferred technical solution, an included angle between the two helical plates of each group of screw-in structure is about 30°, and a spiral rise angle of one of the helical plates is about 15°.

As a further preferred technical solution, a radial dimension of the screw-in structure is greater than an inner diameter dimension of the pile hole, which is used to increase the roughness of the pile body, thus improving uplift performance of the uplift pile.

As a further preferred technical solution, the precast pile body is of a tubular structure, and internally provided with a cavity.

The precast pile formed by processing steel.

As a further preferred technical solution, a bottom end of the precast pile body is provided with a cutting hole communicating with the internal cavity, and the cutting hole is in a diamond shape.

As a further preferred technical solution, the bottom end of the precast pile body is provided with a group of screw-in structure, and two helical plates of the screw-in structure oppositely form the cutting hole communicating with the internal cavity.

As a further preferred technical solution, the cutting hole is in a diamond shape.

As a further preferred technical solution, the curable material is fine aggregate concrete, cement slurry, cement mortar, a cement-soil mixture, or geopolymer-containing solid waste concrete.

When the curable material is the fine aggregate concrete, the strength of the fine aggregate concrete is 15-20 MPa.

When the curable material is the cement slurry, the cement mortar, the cement-soil mixture, or the geopolymer-containing solid waste concrete, the strength is 5-15 MPa.

The present disclosure has the beneficial effects that:
1. Compared with the existing static pressure, high-frequency vibration, hammering methods and the like for the existing precast piles, the method of constructing a pile hole, pouring a curable material in the pile hole and then constructing the precast pile using a spiral implanting method is small in construction noise, environment-friendly and high in construction efficiency. Through the method of constructing the pile hole and then implanting the precast pile into the pile hole, the construction damage to the precast pile can be reduced, and the difficulty of pile sinking can be lowered. In addition, by using the construction method combining cast-in-place and prefabrication, the construction period of the uplift pile can be effectively shortened, the construction efficiency is improved, and the construction quality of the uplift pile is ensured.
2. The uplift pile formed according to the method provided by the present disclosure is a composite pile composed of a precast pile body and a cast-in-situ expanding layer. As the radial dimension of the screw-in structure is larger than the inner diameter dimension of the pile hole, the screw-in structure will inevitably loosen an inner wall of the pile hole in the pile sinking process, the curable material is enabled to set together with a loose position of the inner wall of the pile hole in the setting process, thus transferring a relatively smooth interaction interface of the precast pile body-soil to a bonding strength interface of the expanding layer-soil to increase the roughness of the pile body and improve pile side resistance. Meanwhile, the existence of the expanding layer can prevent the precast pile body from corroding, thus improving the durability of the precast pile body, and increasing the service life of the overall pile body.
3. The helical plate on the precast pile body provided by the present disclosure can enhance the consolidation effect of the precast pile body and the expanding layer and enhance the initial stiffness of the pile body. Meanwhile, the ultimate uplift bearing capacity of the pile can be greatly improved by using end resistance of the expanding layer extending out of the helical plate. Under the same ultimate uplift bearing capacity, the uplift pile provided by the present disclosure can be made in smaller size, thus reducing the engineering cost.

### BRIEF DESCRIPTION OF THE DRAWINGS

The accompanying drawings, which constitute a part of the present disclosure, are used to provide a further understanding of the present disclosure, and the illustrative embodiments of the present disclosure and their descriptions are used to explain the present disclosure, and do not constitute an undue limitation of the present disclosure. In the drawings:

FIG. 1 is a schematic diagram of a construction method for an uplift pile according to an embodiment of the present disclosure;

FIG. 2 is a schematic diagram of an overall structure of an uplift pile according to an embodiment of the present disclosure;

FIG. 3 is a schematic diagram of a precast pile body according to an embodiment of the present disclosure;

FIG. 4 is a front view of a precast pile body according to an embodiment of the present disclosure;

FIG. 5 is a schematic diagram of a B-B direction in FIG. 4;

FIG. 6 is a schematic diagram of an A-A direction in FIG. 4;

FIG. 7 is a schematic structural diagram of a cutting hole according to an embodiment of the present disclosure.

In the drawings: 1—pile hole; 2—precast pile body; 3—expanding layer; 4—helical plate; 5—cutting hole; 6—long auger drill.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the scope of protection of the present disclosure.

In the description of the present disclosure, the terms “longitudinal”, “transverse”, “upper”, “lower”, “front”, “rear”, “left”, “right”, “vertical”, “horizontal”, “top” and “bottom” are based on the orientation or positional relationship shown in the drawings only for convenience of description of the present disclosure and simplification of description rather than indicating or implying that the device or element referred to must have a particular orientation, be constructed and operate in a particular orientation, and thus are not to be construed as limiting the present disclosure. In the present disclosure, the terms “connected” and “connection” should be understood broadly, e.g., may be a fixed connection, or a detachable connection; may be a direct connection, or an indirect connection through an intermediate medium. For those skilled in the art, the specific meanings of the above terms can be understood according to the specific situation.

The present disclosure is described in detail below with reference to the accompanying drawings and embodiments. It should be noted that the embodiments in the present disclosure and the features in the embodiments can be combined with each other without conflict.

According to the construction method for an uplift pile in the present disclosure, a way of combining cast-in-place with a precast pile is used to solve the technical problems of long construction period, low construction efficiency, unstable pile quality and the like caused by the existing uplift pile only being constructed by a cast-in-place method. Meanwhile, a screw-in structure is arranged on the precast pile body. By improving the structure of the precast pile body, the pile sinking construction of the precast pile body is convenient, the noise is reduced, and the integrity of the pile body can be ensured.

An embodiment 1 of construction method for uplift pile is as follows:

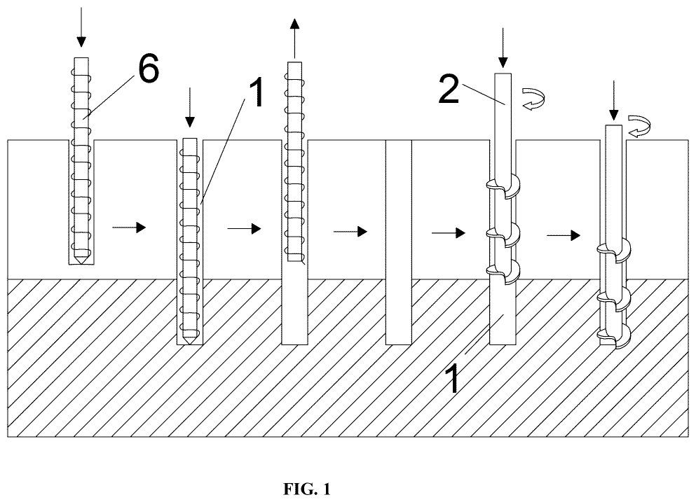

As shown in FIG. 1, the construction method for an uplift pile includes the following construction steps:
Step one. An accurate construction site of an uplift pile is positioned through measurement and positioning to facilitate the construction of the uplift pile.
Step two. As shown in FIG. 1, a long auger drill 6 is used to drill a hole at the construction site. That is, in this embodiment, a spiral drilling mode is used to construct a pile hole 1 underground.
Step three. After the construction of the pile hole 1 is completed, a curable material is poured into the pile hole 1. In this embodiment, a drill bit of the long auger drill 6 is of a hollow structure, and the curable material communicates with the drill bit of the long auger drill 6 by a pump truck through a pipeline, and is transported from the drill bit of the long auger drill 6 to the pile hole 1 for pouring from bottom to top in the pile hole 1. The curable material may employ fine aggregate concrete, cement slurry, cement mortar, a cement-soil mixture, or geopolymer-containing solid waste concrete. When the curable material is the fine aggregate concrete, the strength of the fine aggregate concrete is 15-20 MPa. When the curable material is the cement slurry, the cement mortar, the cement-soil mixture, or the geopolymer-containing solid waste concrete, the strength of the curable material is 5-15 MPa, thus ensuring that the overall strength of the uplift pile meets the requirement.
Step four. Before the curable material is consolidated, a precast pile body 2 is spirally implanted into the pile hole 1 by using a drilling machine. In order to facilitate the precast pile body 2 to be spirally implanted into the pile hole 1, multiple groups of screw-in structures are arranged on an outer side of the precast pile body 2 at intervals in an axial direction.

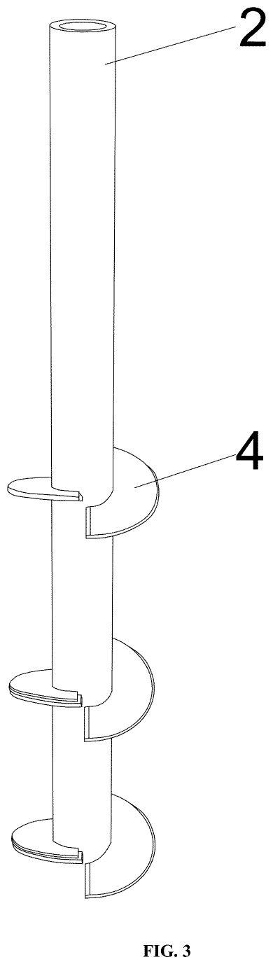

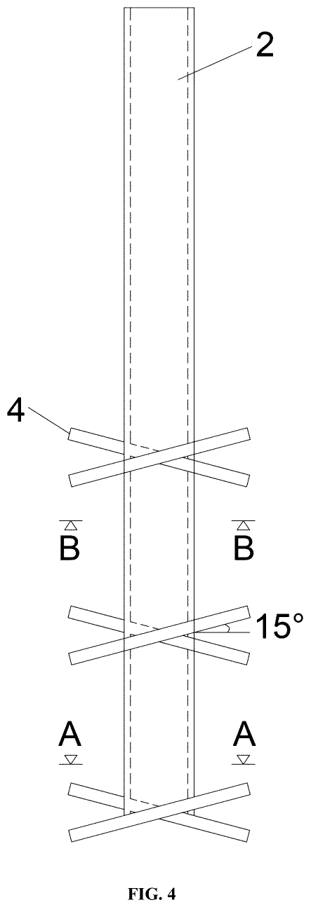

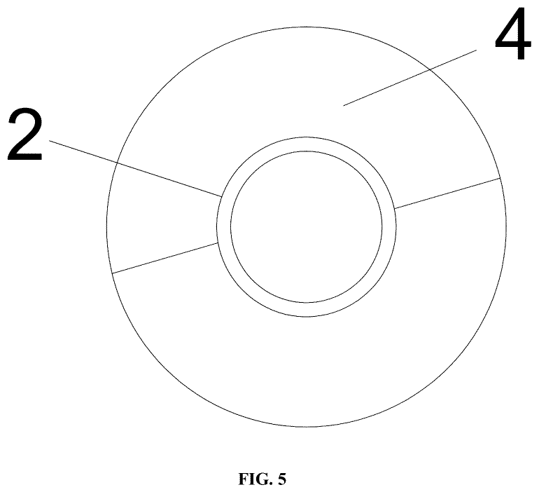

As shown in FIG. 3, FIG. 4 and FIG. 5, each group of screw-in structure includes two helical plates 4 crossed at a set angle, each helical plate 4 extends spirally along the outer side of the precast pile body 2, and the two helical plates 4 are arranged on the precast pile body 2 in a staggered manner. That is, projections of the two helical plates 4 in the axial direction are free of overlapping. In order to give full play of the function of each helical plate 4, in this embodiment, each helical plate 4 extends 180° around a circumferential direction of the precast pile body 2. Therefore, each group of screw-in structure is at least provided with a complete closed loop on an outer side wall of the precast pile body 2. In order to make a first layer of screw-in structure give full play to its uplift bearing function, after the first layer of screw-in structure is completely implanted into the pile hole 1, the upper part of the screw-in structure must meet the minimum soil layer coverage thickness. Specifically, the soil layer cover thickness of the first layer of screw-in structure needs to be calculated according to the soil properties and specific pile type parameters.

Further, in order to guarantee that there is enough soil mass between adjacent screw-in structures to make a formed failure surface fuller and give full play to the uplift bearing function of the screw-in structures and the soil mass between the screw-in structures, a spacing between the adjacent screw-in structures is generally not less than 3 times the diameter of the helical plate 4. Moreover, due to the intermittent arrangement of the screw-in structures, the disturbance on the soil mass in the pile hole I can be reduced to the greatest extent when the precast pile body 2 is spirally implanted, such that the precast pile body 2 only slightly disturbs the soil mass in the screwing-in process and will not screw out the undisturbed soil, thereby reducing the influence on the surrounding environment and improving the bearing capacity of the uplift pile.

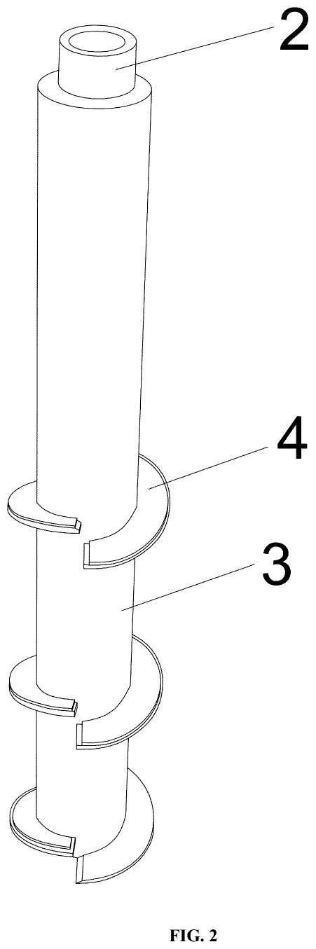

As shown in FIG. 2, a diameter of the precast pile body 2 is less than an inner diameter of the pile hole 1, and thus the curable material can form an expanding layer 3 of the precast pile body 2 after being consolidated. The uplift pile provided by the present disclosure is a composite pile formed by the precast pile body 2 and the expanding layer 3. Compared with the existing overall cast-in-place pile, the expanding layer 3 has shorter construction period and faster setting speed, thus effectively ensuring the construction period. Compared with the precast pile, as the diameter of the precast pile body 2 is less than the inner diameter of the pile hole 1, the pile sinking is convenient, the situation of “pile explosion” is not easy to occur, which is beneficial to ensure the quality of the precast pile body 2 and has low construction noise. Meanwhile, the external cast-in-place expanding layer 3 can effectively ensure the bonding strength of the pile body of the composite pile provided the present disclosure with the soil mass compared with the monolithic precast pile, and further ensure the uplift performance of the uplift pile.

In order to further ensure the uplift performance of the uplift pile, a radial dimension of the screw-in structure is greater than an inner diameter dimension of the pile hole 1, such that the screw-in structure will slightly disturb an inner wall of the pile hole 1 in the process of spirally implanting the precast pile body 2 into the pile hole 1, and the unset curable material can flow into a position disturbed by the screw-in structure. In this case, after the precast pile body 2 is sunk in place, the expanding layer 3 formed by the curable material is more firmly connected to the inner wall of the pile hole 1. Compared with the smooth contact between the precast pile body and the soil mass in the prior art, the uplift pile provided by the present disclosure can increase the bonding strength between the expanding layer 3 and an inner side wall of the pile hole 1, thereby increasing the overall roughness of the uplift pile body and further improving the pile side resistance.

Further, an included angle between the two helical plates 4 of each group of screw-in structure is about 30°, and a spiral rise angle of one helical plate 4 is about 15°. A certain cross angle between the helical plates 4 can reduce the resistance of the pile-screwing process, making the pile easier to screw in. An edge portion of the helical plate 4 has a cutting edge. The specific screw-in principle is that in the screw-in process, firstly, a downward inclined end of the helical plate 4 with a cutting edge is used to cut and loosen the soil layer under the action of a rotating torque and a downward pressure. As the front helical plate 4 has cut and loosened the soil layer, the subsequent helical plate will cut and loose the soil layer along the same cutting trajectory, and the subsequent helical plate can be easier screwed in the soil layer. Meanwhile, there is an included angle between the two helical plates 4, the precast pile body 2 and the expanding layer 3 can be combined more closely, thus ensuring the overall strength of the uplift pile.

As shown in FIG. 3, the precast pile body 2 is of a tubular structure, and internally provided with a cavity. The bottom of the precast pile body 2 communicates with the cavity, such a design can prevent the precast pile body 2 from idling or stopping when the curable material is over-compacted in the spiral pile sinking process of the precast pile body 2. The specific principle is that after the bottom of the cavity communicates with the inner cavity, the curable material, after being compressed to a certain extent by the rotating precast pile body 2, will enter the cavity for pressure relief, thus facilitating the precast pile body 2 to perform pile sinking.

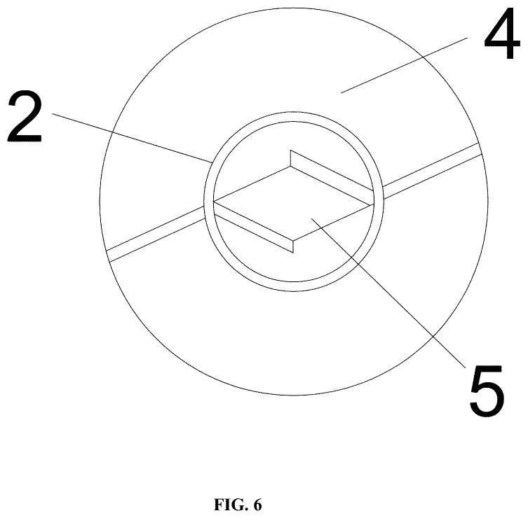

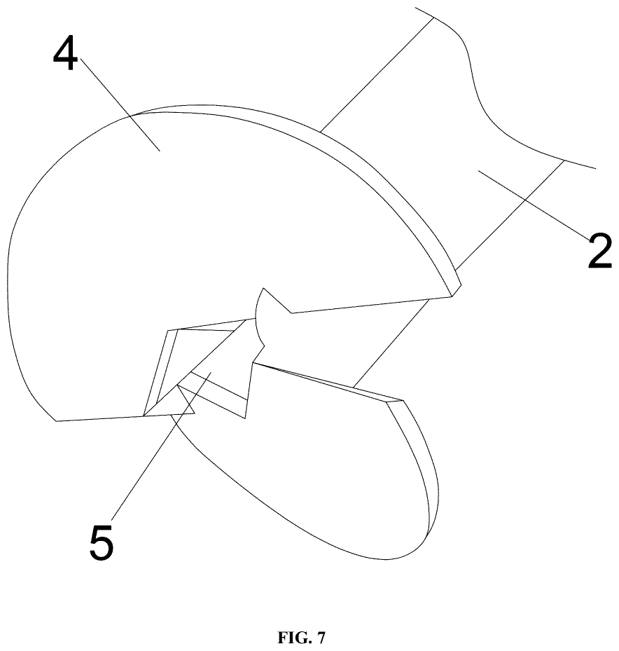

In order to further facilitate the curable material to enter the cavity in the pile sinking process, a cutting hole 5 is formed in a bottom end of the precast pile body 2 to achieve the communication between the bottom of the precast pile body 2 and the cavity. Specifically, as shown in FIG. 6 and FIG. 7, the bottom end of the precast pile body 2 is provided with a group of screw-in structure, and the middle parts of the two helical plates 4 of the screw-in structure oppositely form the cutting hole 5 communicating with the internal cavity. A top view of the cutting hole 5 is in a diamond shape. Due to the structural characteristics of the helical plate 4 itself, the side wall of the cutting hole 5 may have a spiral structure, such that the curable material at the bottom of the precast pile body2 can be conveniently spirally sent into the cavity of the precast pile body 2 during the rotation of the cutting hole 5. Therefore, when the precast pile body 2 is spirally sunk, the precast pile body 2 in spiral rotating makes the cutting hole 5 spirally rotate along with the precast pile body 2, and the curable material can be spirally sent into the cavity of the precast pile body 2. The arrangement of the cutting hole 5 not only can reduce the pile sinking difficulty, and ensure the overall density uniformity of the expanding layer 3. Moreover, the curable material entering the cavity can further enhance the strength of the pile body of the uplift pile. In this embodiment, the precast pile body 2 is formed by processing Q235B steel. The expanding layer 3 outside the precast pile body 2 can prevent the helical plate 4 and the precast pile body 2 from corroding, thus improving the durability of the pile body and prolonging the service life of the pile body.

In this embodiment, the outer diameter of the precast pile body 2 is generally 100 mm-300 mm, a wall thickness is not less than 6 mm, and a length of single precast pile body 2 should not exceed 12 m. The diameter of the helical plate 4 is generally 200 mm to 600 mm, and a thickness of the helical plate 4 should not be less than 6 mm. In this embodiment, the diameter of the helical plate 4 is 500 mm, and the thickness of the helical plate 4 is 8 mm.

In conclusion, the technical solution of the present disclosure, compared with the construction of the uplift pile in the prior art, has the following advantages:

At first, when an ordinary precast pile is subjected to pile sinking construction, the method of hammer piling or static piling is generally adopted, but the hammer piling often causes pile top fragmentation, pile body fracture and pile body inclination, and has obvious influence on the surrounding environment; and the static piling cannot drive the pile into hard rock stratum, and thus is generally not applicable in shallow rock stratum, and moreover, the static piling requires relatively uniform geology, otherwise it is prone to pile explosion. When the construction method provided by the present disclosure is adopted, and the precast pile body 2 is installed, the construction is carried in the curable material in the bored pile hole 1. Moreover, a composite pile mode of cast-in-place and the precast pile can improve the bearing capacity of the uplift pile, and has short construction period, and high construction efficiency. Meanwhile, the screw-in method is used for construction, the noise is small, and the influence on the environment is small.

Secondly, by using the construction method for the uplift pile provided by the present disclosure, compared with an underreamed pile constructed by the cast-in-place mode, the construction period is short, the construction efficiency is high, and the combination with the precast pile makes the overall quality better and the bearing capacity more guaranteed. In addition, compared with the construction of the existing precast pile, the integrity of the precast pile can be easier guaranteed, the construction is easier, such that the uplift pile has both advantages of the cast-in-place pile and the precast pile, and the disadvantages of the cast-in-place pile and the precast pile are overcome.

Finally, by adopting the present disclosure, the reinforcement and underpinning of the existing buildings can no longer be limited to the static pressure method and the high-frequency vibration method. By adopting the screw-in construction method provided by the present disclosure, the construction efficiency is high, and the damage rate to the pile body is relatively low, thereby effectively reducing the construction cost.

Other embodiments of the construction method for an uplift pile are as follows:

The difference between this embodiment and Embodiment 1 is that in Embodiment 1, a way of constructing the pile hole is that the pile hole is drilled by a long auger drill, and in this embodiment, the way of constructing the pile hole is that the hole may be formed by using high-pressure jet grouting.

Other embodiments of the construction method for an uplift pile are as follows:

The difference between this embodiment and Embodiment 1 is that in Embodiment 1, the screw-in structure of the precast pile body includes two helical plates crossed at a set angle, while in this embodiment, the screw-in structure may be one helical plate, at this time, the spiral rise angle of each group of helical plate gradually increases from the bottom end to the top.

It may be understood that above description is exemplary, which is not limited by the embodiment of the present disclosure.

The above is only the preferred embodiment of the present disclosure, and is not used to limit the present disclosure. Any modification, equivalent substitution, improvement, etc. made within the spirit and principle of the present disclosure should be included in the scope of protection of the present disclosure.

What is claimed is:

1. A construction method for an uplift pile, comprising the following steps:
Step one, measuring and positioning to obtain an accurate construction site of an uplift pile;
Step two, constructing a pile hole (1) underground at the construction site;
Step three, pouring a curable material in the pile hole (1); and
Step four, spirally implanting a precast pile body (2) into the pile hole (1) before the curable material is consolidated, wherein the precast pile body (2) is provided with multiple groups of screw-in structures at intervals in an axial direction for screwing the precast pile body (2) into the pile hole (1).

2. The construction method for an uplift pile according to claim 1, wherein a diameter of the precast pile body (2) is less than an inner diameter of the pile hole (1), and the curable material is set to form an expanding layer (3) of the precast pile body (2);
each group of screw-in structure comprises two helical plates (4) crossed at a set angle, each helical plate (4) extends spirally along an outer side of the precast pile body (2), and the two helical plates (4) are arranged on the precast pile body (2) in a staggered manner.

3. The construction method for an uplift pile according to claim 2, wherein each helical plate (4) extends about 180° around a circumferential direction of the precast pile body (2).

4. The construction method for an uplift pile according to claim 3, wherein an included angle between the two helical plates (4) of each group of screw-in structure is about 30°, and a spiral rise angle of one of the helical plates (4) is about 15°.

5. The construction method for an uplift pile according to claim 1, wherein a radial dimension of the screw-in structure is greater than an inner diameter dimension of the pile hole (1), which is used to increase the roughness of the pile body, thus improving uplift performance of the uplift pile.

6. The construction method for an uplift pile according to claim 5, wherein the precast pile body (2) is of a tubular structure, and internally provided with a cavity; and
the precast pile body (2) is formed by processing steel.

7. The construction method for an uplift pile according to claim 4, wherein a bottom end of the precast pile body (2) is provided with a cutting hole communicating with the internal cavity, and the cutting hole (5) is in a diamond shape.

8. The construction method for an uplift pile according to claim 4, wherein the bottom end of the precast pile body (2) is provided with a group of screw-in structure, and two helical plates (4) of the screw-in structure oppositely form the cutting hole (5) communicating with the internal cavity.

9. The construction method for an uplift pile according to claim 8, wherein the cutting hole (5) is in a diamond shape.

10. The construction method for an uplift pile according to claim 1, wherein the curable material is fine aggregate concrete, cement slurry, cement mortar, a cement-soil mixture, or geopolymer-containing solid waste concrete;
when the curable material is the fine aggregate concrete, the strength of the fine aggregate concrete is 15-20 MPa; and
when the curable material is the cement slurry, the cement mortar, the cement-soil mixture, or the geopolymer-containing solid waste concrete, the strength is 5-15 MPa.

11. The construction method for an uplift pile according to claim 2, wherein a radial dimension of the screw-in structure is greater than an inner diameter dimension of the pile hole (1), which is used to increase the roughness of the pile body, thus improving uplift performance of the uplift pile.

12. The construction method for an uplift pile according to claim 3, wherein a radial dimension of the screw-in structure is greater than an inner diameter dimension of the pile hole (1), which is used to increase the roughness of the pile body, thus improving uplift performance of the uplift pile.

13. The construction method for an uplift pile according to claim 4, wherein a radial dimension of the screw-in structure is greater than an inner diameter dimension of the pile hole (1), which is used to increase the roughness of the pile body, thus improving uplift performance of the uplift pile.

14. The construction method for an uplift pile according to claim 2, wherein the curable material is fine aggregate concrete, cement slurry, cement mortar, a cement-soil mixture, or geopolymer-containing solid waste concrete;
when the curable material is the fine aggregate concrete, the strength of the fine aggregate concrete is 15-20 MPa; and
when the curable material is the cement slurry, the cement mortar, the cement-soil mixture, or the geopolymer-containing solid waste concrete, the strength is 5-15 MPa.

15. The construction method for an uplift pile according to claim 3, wherein the curable material is fine aggregate concrete, cement slurry, cement mortar, a cement-soil mixture, or geopolymer-containing solid waste concrete;
when the curable material is the fine aggregate concrete, the strength of the fine aggregate concrete is 15-20 MPa; and
when the curable material is the cement slurry, the cement mortar, the cement-soil mixture, or the geopolymer-containing solid waste concrete, the strength is 5-15 MPa.

16. The construction method for an uplift pile according to claim 4, wherein the curable material is fine aggregate concrete, cement slurry, cement mortar, a cement-soil mixture, or geopolymer-containing solid waste concrete;
when the curable material is the fine aggregate concrete, the strength of the fine aggregate concrete is 15-20 MPa; and
when the curable material is the cement slurry, the cement mortar, the cement-soil mixture, or the geopolymer-containing solid waste concrete, the strength is 5-15 MPa.
